(19) United States
(12) Patent Application Publication
(10) Pub. No.: US 2021/0403233 A1
(43) Pub. Date: Dec. 30, 2021

(54) DISCRETE BATCH MODE SECURE RECYCLE BOX

(71) Applicant: Nengfue Lee, Maplewood, MN (US)

(72) Inventor: Nengfue Lee, Maplewood, MN (US)

(21) Appl. No.: 16/911,688

(22) Filed: Jun. 25, 2020

(51) Int. Cl. B65F 1/14

(52) U.S. Cl. CPC B65F 1/1426; B65F 2240/156; B65F 2210/184; B65F 2210/169

(57) ABSTRACT

The present invention is intended for commercial businesses to store their confidential papers in until the papers may be picked up for shredding with a private company. The recycle box is made of aluminum, strong wood, and strong plastic. The present invention offers a higher level of security because the machine does not have a fixedly open drop slot. The recycle box looks appealing and can be placed in convenient areas in any work environment. The recycle box has a loading capacity of up to 500 sheets of paper.

### BACKGROUND

Many business offices deal with the disposal of confidential records. The current solution is to keep a shredder machine in the office where employees of the company may directly destroy such documents. Businesses may instead hire a company to do the paper shredding for them, which necessitates a secure place to keep the confidential documents until they can be picked up to be shredded. In both cases, the main concerns are that the documents stay confidential, and that the process is easy, appealing, and accessible to workers. There have been no products available as original equipment or as an aftermarket to address this problem.

The product of paper shredder has many makes and models from various companies but may include: up to 3 or up to 5 minutes of continual use before cool down, from up to 6 or up to 12 pieces of paper at a time, with a 3 or 4 gallon capacity bin. Such a machine does not facilitate ease of use for larger batches of paper, longer run times, or larger overall disposal capacity. Users may need to take time to separate smaller piles of paper to feed into the shredder, wait between shredding sessions, and frequently empty the small bin. There have been no products available as original equipment or as an aftermarket to address this problem.

There exists a need for a Business Confidential Records Secure Recycle Box that is not being met by any known or disclosed device or system of present.

### SUMMARY OF THE INVENTION

The present invention is intended for commercial businesses to store their confidential papers in until the papers may be picked up and shredded with a private company. The present invention offers a higher level of security because the machine does not have a fixedly open drop slot. The recycle box looks appealing and can be placed in convenient areas in any work environment. The recycle box has a large loading capacity of up to 500 sheets of paper.

### BRIEF DESCRIPTION OF THE DRAWINGS

FIG. 1 is a depiction of the recycle box in accordance with an embodiment of the present disclosure.

FIG. 2 is a depiction of an exploded view of the recycle box in accordance with an embodiment of the present disclosure.

FIG. 3 is a flow diagram of a method for recycling bulk paper via a discrete batch mode secure recycle box in accordance with an embodiment of the disclosure.

FIG. 4 is a flow diagram of methods of managing the discrete batch mode secure recycle box in accordance with an embodiment of the disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

A common paper shredder has a fixedly open slot on the top of the machine through which to insert papers. Such a fixedly open slot is often thin to secure the papers inside the bin. A moveable opening would improve appearance and use while maintaining security of the machine. There have been no products available as original equipment or as an aftermarket to address this problem.

Throughout the present disclosure the term secure is used to refer to restricted or limited access, accessible by the owner of the document and few or no others. The term recycle refers to the shredding and or micro-cutting of paper documents to then be recycled for reuse with other paper in a recycling facility.

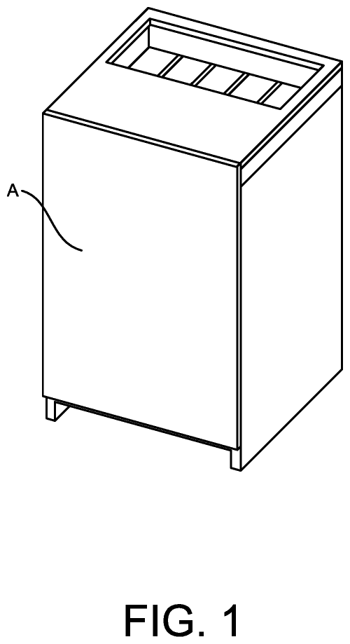

FIG. 1 is a depiction of the recycle box in accordance with an embodiment of the present disclosure. The recycle box is made of aluminum, strong wood, and strong plastic to keep papers secure.

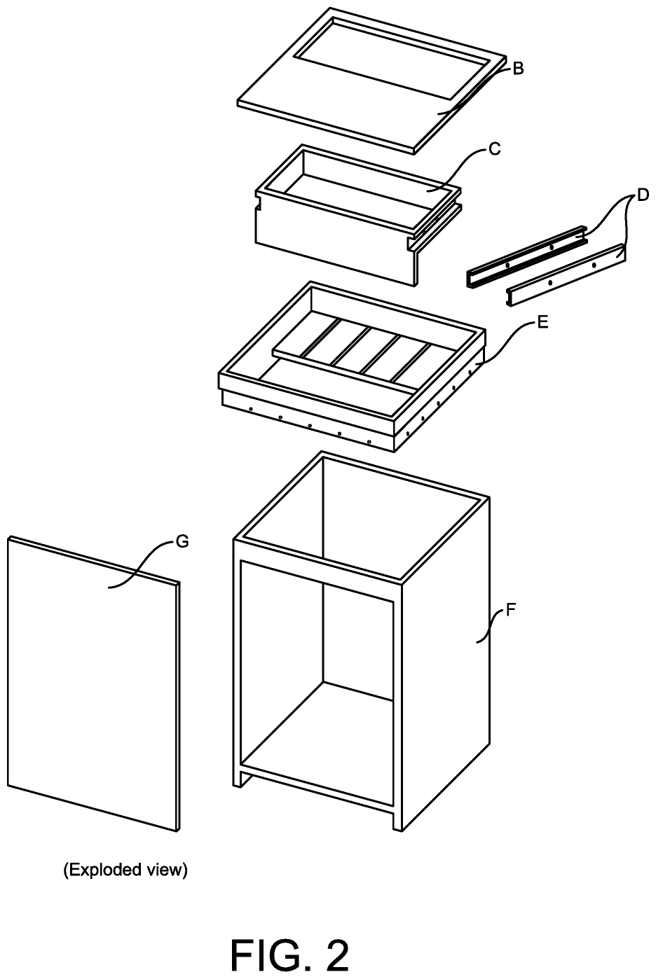

FIG. 2 is depiction of an exploded view of the recycle box in accordance with an embodiment of the present disclosure. The recycle box includes a top cover B, slider box C, soft close ball bearing slides D, inside box E, main box F, and front cover G. When a person uses the invention, they may place up to 500 pieces of paper into the slide tray on the top of the box then push the handle and all the papers in the open space drop down into the secure box F. The slide tray returns to its place automatically, via spring-assist mounted soft close tray slides D. The slide tray is fully covered by the top cover B when the paper is dropped into the bin.

In an embodiment of the disclosure, the slider tray is made of pieces B, D, C, and E. Pieces B and E are static, unmoving. Piece C is the same width but half the length of piece E allowing it to form the vertical sides of a box while half of E forms the bottom horizontal side of the box. Thus, the person using the invention puts papers through the top cover B, to rest inside the slider box C and on top of the inside box E. When the handle is pushed, the spring tray slides D move the slider box C across the inside box E to the open portion of the same, underneath the solid panel of the top cover B.

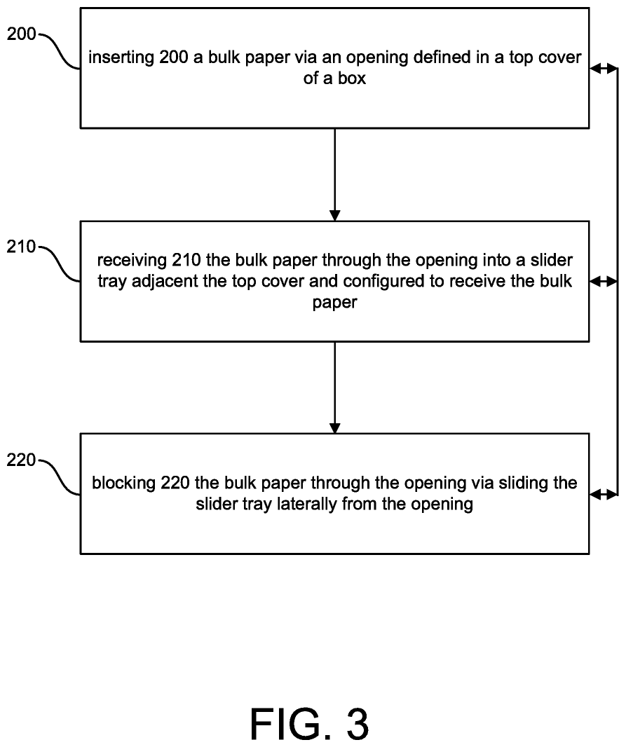

FIG. 3 is a flow diagram of a method for recycling bulk paper via a discrete batch mode secure recycle box in accordance with an embodiment of the disclosure. The method includes inserting 200 a bulk paper via an opening defined in a top cover of a box. The method also includes receiving 210 the bulk paper through the opening into a slider tray adjacent the top cover and configured to receive the bulk paper. The method additionally includes blocking 220 the bulk paper through the opening via sliding the slider tray laterally from the opening.

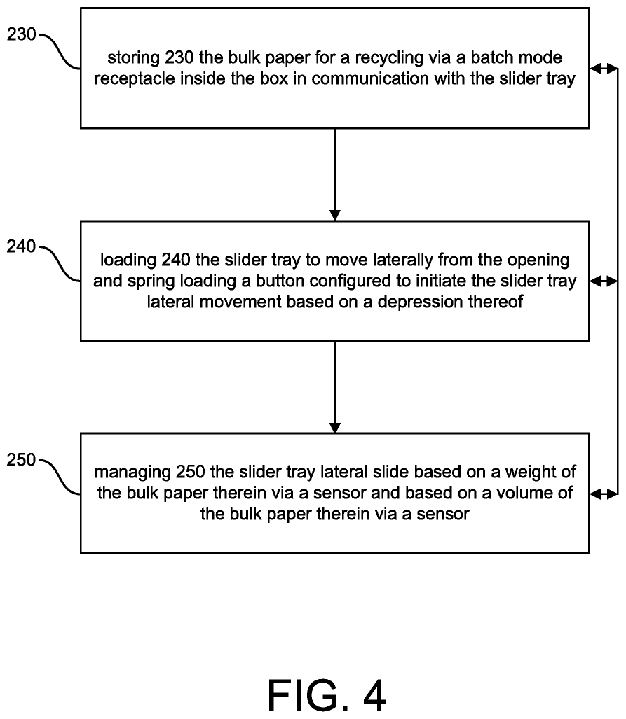

FIG. 4 is a flow diagram of methods of managing the discrete batch mode secure recycle box in accordance with an embodiment of the disclosure. The method further includes storing 230 the bulk paper for a recycling via a batch mode receptacle inside the box in communication with the slider tray. The embodied methods include spring loading 240 the slider tray to move laterally from the opening and spring loading a button configured to initiate the slider tray lateral movement based on a depression thereof. The embodied methods also include shredding the bulk paper via a shredder adjacent the batch mode receptacle, mounting a plurality of slides adjacent the slider tray and mounted to an underside of the top cover, moving the slider tray laterally from the opening via a step motor. The embodied methods also include managing 250 the slider tray lateral slide based on a weight of the bulk paper therein via a sensor and based on a volume of the bulk paper therein via a sensor.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A paper recycling box comprising:
a. a top cover defining an opening for a bulk paper insertion therethrough;
b. a slider tray adjacent the top cover and configured to receive the bulk paper through the opening and slide laterally from the opening;
c. a batch mode receptacle inside the box and configured to receive the bulk paper from the slider tray for processing.

2. The box of claim 1, further comprising a spring loaded to move the slider tray laterally from the opening.

3. The box of claim 1, further comprising a paper shredder adjacent the batch mode receptacle.

4. The box of claim 1, further comprising a plurality of slides adjacent the slider tray and mounted thereto and mounted to an underside of the top cover.

5. The box of claim 1, further comprising a step motor configured to move the slider tray laterally from the opening.

6. The box of claim 1, further comprising a spring loaded button configured to initiate the slider tray lateral movement based on a depression thereof.

7. The box of claim 1, further comprising a security lock on the batch mode receptacle inside the box, the security lock accessed from outside the box.

8. The box of claim 1, further comprising a state machine circuit configured to manage the slider tray lateral slide based on a weight of the bulk paper therein.

9. The box of claim 1, further comprising a state machine circuit configured to manage a lateral slide of the slider tray based on a volume of the bulk paper therein.

10. The box of claim 1, further comprising a front panel of the box, the front panel configured to open on a hinge side and enable access to the batch mode receptacle.

11. A method of recycling paper, the method comprising:
a. inserting a bulk paper via an opening defined in a top cover of a box;
b. receiving the bulk paper through the opening into a slider tray adjacent the top cover and configured to receive the bulk paper;
c. blocking the bulk paper through the opening via sliding the slider tray laterally from the opening;
d. storing the bulk paper for a recycling via a batch mode receptacle inside the box in communication with the slider tray.

12. The method of claim 1, further comprising spring loading the slider tray to move laterally from the opening.

13. The method of claim 1, further comprising shredding the bulk paper via a shredder adjacent the batch mode receptacle.

14. The method of claim 1, further comprising mounting a plurality of slides adjacent the slider tray and mounted to an underside of the top cover.

15. The method of claim 1, further comprising moving the slider tray laterally from the opening via a step motor.

16. The method of claim 1, further comprising spring loading a button configured to initiate the slider tray lateral movement based on a depression thereof.

17. The method of claim 1, further comprising securing a lock on the batch mode receptacle inside the box, the security lock accessed from outside the box.

18. The method of claim 1, further comprising managing the slider tray lateral slide based on a weight of the bulk paper therein via a sensor.

19. The method of claim 1, further comprising further managing a lateral slide of the slider tray based on a volume of the bulk paper therein via a sensor.

20. The method of claim 1, further comprising a front panel of the box, the front panel configured to open on a hinge side and enable access to the batch mode receptacle.
